(19) United States
(12) Patent Application Publication
(10) Pub. No.: US 2024/0295201 A1
(43) Pub. Date: Sep. 5, 2024

(54) NEGATIVE PRESSURE GENERATOR AND FUEL TANK VENTILATION

(71) Applicant: WOCO Industrietechnik GmbH, Bad Soden-Salmuenster (DE)

(72) Inventors: Jan Felix Neumann, Gelnhausen (DE); Caroline Schäfers, Offenbach Am Main (DE); David Andel, Gruendau (DE)

(73) Assignee: WOCO Industrietechnik GmbH, Bad Soden-Salmuenster (DE)

(21) Appl. No.: 18/004,472

(22) PCT Filed: Jul. 7, 2021
(86) PCT No.: PCT/EP2021/068854

§ 371 Date: Jul. 7, 2023

(30) Foreign Application Priority Data
Jul. 8, 2020 (DE) 102020118017.9

(51) Int. Cl. F02M 25/08; F02M 35/10

(52) U.S. Cl. CPC F02M 25/0872; F02M 25/089; F02M 35/10118; F02M 35/10157; F02M 35/10229; F02M 35/10321

(57) ABSTRACT

A vacuum generator for fuel tank ventilation may include a fluid feed-through body having at least two plastic parts, in particular plastic shells. The fluid feed-through body may have an overpressure conduit section connectable to an overpressure source, in particular downstream of a turbo charger and downstream of a throttle valve of a motor vehicle engine, an intake conduit section connectable to the fuel tank and a delivery conduit section connectable to a motor vehicle engine, and a venturi nozzle into which the overpressure conduit section opens. The intake conduit section may open into a vacuum side of the venturi nozzle. At least the venturi nozzle may be made of a plastic piece.

### CROSS REFERENCE TO RELATED APPLICATIONS

This patent application is a United States National Stage patent application of PCT International Application No. PCT/EP2021/068854, filed Jul. 7, 2021, which claims priority to German Patent Application No. 10 2020 118 017.9, filed Jul. 8, 2020. Each of these applications is incorporated herein by reference in its entirety.

### BACKGROUND

### Field

The present disclosure relates to a vacuum generator for fuel tank ventilation. Furthermore, the present disclosure provides a fuel tank ventilation for a motor vehicle.

### Related Art

A well-known phenomenon in fuel tanks in motor vehicles is the evaporation of fuel in the fuel tank. This results in additional hydrocarbon emissions. To protect the environment, the hydrocarbon emissions must be prevented from escaping into the atmosphere. In the state of the art, there are numerous solutions in the form of tank ventilation systems that use activated carbon filters to capture the evaporated hydrocarbons. However, the activated carbon filters are limited in their storage capacity and become clogged after a certain period of operation. The activated carbon filters are cleaned, for example, by flushing the activated carbon filter with fresh air. It has also proven advantageous to return the hydrocarbon enriched purge air to a combustion process in the motor vehicle.

In general, tank venting systems, such as those known from DE 10 2011 054 851 A1, have an activated carbon filter line that leads from the activated carbon filter to an intake area of a motor vehicle engine and in which a controllable tank vent valve is integrated. For flushing/cleaning, a vacuum from the intake area of the motor vehicle engine is used so that the activated carbon filter is flushed via a fresh air line. This rinsing air enriched with hydrocarbons is fed to the motor vehicle engine in the intake area for combustion. The activated carbon filter is therefore flushed with ambient air from the intake area by the application of vacuum and passively regenerated. Another generic tank ventilation system is known, for example, from DE 10 2016 210 570 A1.

However, operating conditions do occur, for example with a wide-open throttle valve, in which the vacuum in the intake area is not great enough to draw in purge air to regenerate or purge the activated carbon filter. Such a case occurs, for example, with turbocharged engines in the turbocharged operating state, as there is then hardly any vacuum in the intake area. To solve this problem, venturi nozzles are used to generate a vacuum for flushing the activated carbon filter.

The known tank ventilation systems, in particular those described in DE 10 2016 210 570 A1 and DE 10 2011 054 851 A1, are still subject to unsealing and leakage flows into the atmosphere. Furthermore, there is potential for improvement with regard to manufacturing.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 illustrates a fuel tank ventilation system according to an exemplary embodiment of the disclosure in a first operating state, and which is integrated in a motor vehicle.

FIG. 2 the fuel tank ventilation of FIG. 1 shown in a further operating state according to an exemplary embodiment.

FIG. 3 a perspective view of a vacuum generator according to an exemplary embodiment of the disclosure.

FIG. 4 a top view of a vacuum generator according to an exemplary embodiment of the disclosure.

FIG. 5 a sectional view of the vacuum generator shown in FIG. 4 along the line V-V.

FIG. 6 a side view of the vacuum generator shown in FIGS. 4 and 5, indicated by the arrow VI in FIG. 4, according to an exemplary embodiment.

FIG. 7 a sectional view of the vacuum generator along line VII-VII of FIG. 6.

FIG. 8 a sectional view of the fluid flow guide body corresponding to line VIII-VIII of FIG. 6.

The exemplary embodiments of the present disclosure will be described with reference to the accompanying drawings. Elements, features and components that are identical, functionally identical and have the same effect are-insofar as is not stated otherwise-respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure.

An object of the present disclosure is to provide a vacuum generator as well as a fuel tank ventilation which has a compact structure, is easy to manufacture, and has improved fluid tightness.

The disclosure provides a vacuum generator, also called underpressure generator. The vacuum generator may be for fuel tank ventilation, but is not limited thereto. The fuel tank ventilation, also called tank ventilation system, can in principle be realised in general construction and with regard to the mode of operation corresponding to the fuel tank ventilation systems, in particular tank ventilation systems, as described with reference to the prior art. Fuel tank vents are generally used in motor vehicles which have a fuel tank in which fuel is provided. The fuel can serve as an energy supplier for a motor vehicle engine, in particular an internal combustion engine, of the motor vehicle.

The vacuum generator according to the disclosure comprises a fluid feed-through body consisting of at least two plastic parts. The plastic parts can be realised or shaped as plastic shells. The fluid feed-through body made of plastic can serve to guide, direct and/or deflect fluid flows, in particular gas flows, which occur during fuel tank ventilation. The fluids are on the one hand air, in particular ambient air, and on the other hand a fuel/air mixture which results from fuel tank ventilation and escapes from the fuel tank and is drawn off or sucked in by means of the vacuum generator. The vacuum generator or fluid feed-through body may have three conduit sections that open into a common fluid chamber. The three conduit sections may provide the respective fluidic connection with the adjacent components, for example, within the motor vehicle engine. For example, the three conduit sections have a substantially cylindrical pipe-shaped cross-section and/or a constant wall thickness.

The fluid feed-through body has an overpressure conduit section. The overpressure conduit section can be connected to an overpressure source, which can be located, for example, downstream of a turbo charger, in particular downstream of the pressure side of a turbo charger, and downstream of a throttle valve of a motor vehicle engine. In particular, in the so-called charging mode of a motor vehicle engine and with the throttle valve open, a strong overpressure results downstream of the throttle valve, relative to the surroundings as well as relative to the fuel tank, which can be used for fuel tank ventilation. The overpressure conduit section may be connectable or connected to this overpressure section. The fluid feed-through body further comprises an intake conduit section connectable or connected to the fuel tank. Via the intake conduit section, an air/fuel mixture from the fuel tank, in particular from an activated carbon filter associated therewith, which captures and stores evaporated hydrocarbons, is supplied for fuel tank ventilation. During fuel tank ventilation, the activated carbon filter can be cleaned by flushing it with fresh air. Further, the fluid feed-through body comprises a delivery conduit section. Via the delivery conduit section, the hydrocarbon enriched purge/intake air can be supplied to a motor vehicle engine, in particular a combustion process. Accordingly, the delivery conduit section may be connectable or connected to the motor vehicle engine. The fluid feed-through body may accordingly form a type of housing structure which contains the above-mentioned three conduit sections and is responsible for combining the incoming fluid flows and for delivering the combined fluid flow, for example, towards the motor vehicle engine. The use of plastic for the plastic parts of the fluid feed-through body is associated with advantages in terms of cost, manufacturability as well as weight. In an exemplary embodiment, the fluid feed-through body consists exclusively of at least two plastic parts.

Furthermore, the vacuum generator according to the disclosure comprises a venturi nozzle into which the overpressure conduit section opens or leads, wherein the intake conduit section opens or leads into a vacuum side of the venturi nozzle. The venturi nozzle, also called a venturi pipe, may have a substantially pipe-like cross-sectional structure which narrows or tapers in the direction of fluid flow, for example by two crowns directed towards each other which are united at a point of their smallest diameter. The function of a venturi nozzle is generally known. A venturi nozzle generally makes use of the Venturi effect, according to which the flow velocity of a fluid flow is inversely proportional to the fluid feed-through cross-section within the venturi nozzle, in particular the pipeline average, so that the volumetric flow is constant over any cross-section. Furthermore, the venturi nozzle makes use of the Bernoulli effect, according to which a fluid flow at a location where the flow velocity is higher or faster, the pressure of the fluid flow is lower. The venturi nozzle can therefore be used to generate a high vacuum relative to the environment and relative to the fuel tank in a simple and compact manner, which can be used to clean the activated carbon filter by sucking in or drawing off the fuel/air mixture that accumulates on or in it. This is also achieved by connecting the intake conduit section to the vacuum side of the venturi nozzle, in particular to a maximum vacuum area of the venturi nozzle. The vacuum resulting on the vacuum side of the venturi nozzle causes fluid to be sucked in or drawn off via the intake conduit section. The sucked-in fluid, in particular air/fuel mixture, is fed in the fluid feed-through body on the vacuum side of the venturi nozzle, for example to the delivery conduit section, in order to use it to feed the sucked-in fuel/air mixture, for example to the motor vehicle engine, in particular to a combustion process. After combustion of the fuel/air mixture, it can then be delivered to the environment, in particular filtered and/or purified, via an exhaust system of the motor vehicle engine.

According to the disclosure, at least the venturi nozzle is made of one plastic piece. The one-piece manufacture of the venturi nozzle represents a fluid-tight, in particular gas-tight, structure. A further advantage is that the venturi nozzle cannot be accessed non-destructively. This makes it possible, for example, to meet the increasingly stringent requirements for air pollution control in motor vehicles. On the other hand, it is thus possible to produce a line structure that is as compact as possible and as economical as possible. For example, the vacuum generator consists exclusively of the fluid feed-through body, consisting of the three conduit sections mentioned above, and the venturi nozzle. Apart from seals or, for example, fastening devices such as screws or the like, the vacuum generator does not require any other components.

In an exemplary embodiment of the present disclosure, the at least two plastic parts are each manufactured by means of an injection moulding process, in particular by injection moulding. Injection moulding allows the plastic parts to be produced economically in large quantities. The process is very flexible in terms of shaping. In addition, injection moulding is characterised by high dimensional accuracy.

According to another exemplary embodiment of the vacuum generator according to the disclosure, the at least two plastic parts are welded together, in particular by ultrasonic welding. In this way, a fluid feed-through body can be created which is particularly fluid-tight, in particular gas-tight, and stable. Access to the interior of the respective conduit section, in particular the venturi nozzle, is not possible in a non-destructive manner.

According to an exemplary further development of the vacuum generator according to the disclosure, the venturi nozzle is demoulded by a slide in the injection mould. Alternatively or additionally, it can be provided that the venturi nozzle has a conical shape, in particular a truncated conical shape, at least in sections. Accordingly, it is possible to produce the venturi nozzle already in the injection mould during injection moulding of the at least two plastic parts, in particular of that plastic part which forms the venturi nozzle.

In another exemplary embodiment of the present disclosure, the venturi nozzle and the overpressure conduit section and/or the intake conduit section are made of one plastic piece. The plastic piece may form one of the at least two plastic parts. Thus, a vacuum generator is created which is particularly easy to realise by means of injection moulding of the at least two plastic parts and, if necessary, subsequent welding of the at least two plastic parts. The fluid feed-through body can already be produced in an injection moulding process to the extent that the overpressure conduit section, the venturi nozzle and/or the intake conduit section are produced.

According to another exemplary embodiment of the present disclosure, the delivery conduit section, in particular one conduit half of the delivery conduit section, is additionally made of a plastic piece with venturi nozzle and overpressure conduit section and/or intake conduit section. In the second injection moulding process, for example, the at least one second plastic part is produced, which can substantially exclusively mould the other conduit half of the delivery conduit section. The fluid feed-through body can be completely fabricated by subsequent stacking and welding together. For example, the venturi nozzle and the overpressure conduit section form a common conduit structure which may extend in a straight line and which opens into a vacuum chamber. Furthermore, the intake conduit section, which is, for example, manufactured in one piece with the venturi nozzle and the overpressure conduit section, opens into the vacuum chamber. The vacuum chamber can be made in two parts corresponding to the delivery conduit section, namely from the at least two plastic parts.

In a further exemplary embodiment of the vacuum generator according to the disclosure, at least one of the conduit sections is formed at least in sections by both of the at least two plastic parts. For example, this is the delivery conduit section. Furthermore, a vacuum chamber adjoining a vacuum side of the venturi nozzle can be formed by both of the at least two plastic parts and can be hermetically sealed, for example, by welding the at least two plastic parts.

According to another exemplary embodiment of the present disclosure, the at least two plastic parts each have and/or form a conduit half of at least one of the conduit sections, in particular of the delivery conduit section. Furthermore, the at least two plastic parts can be welded together to form the corresponding conduit section, in particular the delivery conduit section, in particular by means of ultrasonic welding. For example, the respective conduit halves of the at least two plastic parts are shape-matched to one another, in particular of the same dimensions in cross-section, so that a compact, in particular rotationally symmetrical conduit structure is created. Furthermore, it can be ensured in this way that the mutually facing boundary and/or connecting surfaces of the respective conduit halves face each other in such a way that they can be welded to each other in a simple manner. For example, the respective conduit halves are mirror-symmetrically shaped with respect to the connecting and/or boundary surface that defines the welding plane.

According to an exemplary further development of the vacuum generator according to the disclosure, the venturi nozzle and the overpressure conduit section are demoulded in the injection mould in one demoulding direction, in particular by means of the same slide. Thus, both the venturi nozzle and the overpressure conduit section can be produced in one process step, wherein a particularly flexible shaping with respect to venturi nozzle and overpressure conduit section is possible, in particular by varying the slide geometry.

In a further exemplary embodiment of the vacuum generator according to the disclosure, a vacuum chamber is formed downstream of the venturi nozzle, in particular adjoining and/or as part of the vacuum side of the venturi nozzle. The intake conduit section opens into the vacuum chamber so that, when a fluid flow flows through the overpressure conduit section, in particular a fluid flow that is at overpressure with respect to the environment and/or the activated carbon filter, as a result of a pressure difference between the vacuum chamber and the intake conduit section, in particular fuel tank and/or activated carbon filter, fluid, in particular gas, in particular a carbon/air mixture or a fuel/air mixture, can be drawn in from the fuel tank or the activated carbon filter via the intake conduit section into the vacuum chamber and the delivery conduit section, in particular can be delivered via the delivery conduit section. Thus, the shape, in particular the geometry, of the venturi nozzle and the arrangement of the individual conduit sections realise a particularly compact fluid feed-through body that is easy to manufacture, and a reliable fuel tank ventilation is created.

In another exemplary embodiment of the present disclosure, the intake conduit section and the overpressure conduit section lie in one plane. Alternatively or additionally, the intake conduit section and the overpressure conduit section may be oriented at least partially substantially parallel to each other. At least one of the intake conduit section and the overpressure conduit section may be curved in sections, in particular the intake conduit section has a curved region to open into a vacuum chamber formed downstream of the venturi nozzle and extending substantially in the overpressure conduit section longitudinal direction and/or demoulding direction.

According to a further exemplary further development of the vacuum generator according to the disclosure, a separating plane between the at least two plastic parts is essentially parallel to the plane of the overpressure conduit section and the vacuum conduit section. This makes the assembly, in particular the welding together of the at least two plastic parts, particularly easy.

In a further exemplary embodiment of the vacuum generator according to the disclosure, at least one of the plastic parts is substantially planar and/or shell-like. The shell-like structure of the at least one of the at least two plastic parts ensures, when the at least two plastic parts are fastened, in particular welded to one another, to form the fluid feed-through body, that the fluid feed-through body has fluid feed-through sections, namely the conduit sections, in order to pass, guide through and/or deflect the individual fluid flows, in particular in order to implement the function of fuel tank ventilation.

According to a further exemplary further development of the disclosure, which can be combined with the preceding aspects and/or exemplary embodiments, a fuel tank ventilation, in particular a tank ventilation system, is provided for a motor vehicle. The general operation of the fuel tank ventilation system and the structure may be designed analogously to the exemplary embodiments and aspects according to the disclosure as described above.

The fuel tank ventilation according to the disclosure comprises a fuel tank with a fluid cleaning element, such as an activated carbon filter. Hydrocarbons vaporised in the fuel tank are deposited and stored in the fluid cleaning element.

Further, the fuel tank ventilation comprises an intake duct fluidly connected to the fuel tank, in particular an intake duct fluidly connected to the fluid cleaning element. Furthermore, the fuel tank ventilation comprises an overpressure duct to be connected to an overpressure source, in particular downstream of a turbo charger and upstream of a throttle valve of a motor vehicle engine, for example a corresponding conduit section. Via the overpressure duct, fluid which is in overpressure with respect to the environment and/or with respect to a fluid pressure prevailing in the fluid purification element can be present. The fuel tank ventilation further comprises an exhaust duct to be connected to a motor vehicle engine. Via the exhaust duct, fluid, in particular a fuel/air mixture or a carbon/air mixture, which has been sucked in or drawn off by the fluid cleaning element, in particular during the combustion process within the motor vehicle engine, can be supplied to the motor vehicle engine.

According to the disclosure, the fuel tank ventilation also comprises a vacuum generator configured according to one of the preceding aspects and/or exemplary embodiments and fluidly connected to the intake duct, the exhaust duct and the overpressure duct. For example, the overpressure conduit section of the vacuum generator is fluidly connected to the overpressure duct, the intake conduit section of the vacuum generator is fluidly connected to the intake duct, and the delivery conduit section of the vacuum generator is fluidly connected to the delivery duct.

According to an exemplary embodiment of the fuel tank ventilation according to the disclosure, it further comprises a resonator for vibration and/or noise reduction. For example, the resonator is arranged downstream of an intake device for supplying the turbo charger and/or the motor vehicle engine with fresh air. The resonator can serve to reduce the vibrations and/or noises occurring during the intake of ambient air, in particular to dampen and/or attenuate them. For example, the resonator is arranged upstream of the turbo charger. The resonator has a resonator housing in which the vacuum generator is integrated. The resonator housing can be at least in two parts and be formed by the at least two plastic parts of the fluid feed-through body.

In the following description of exemplary embodiments of the present disclosure, a vacuum generator according to the disclosure is generally designated by reference numeral 1. A fuel tank ventilation system according to the disclosure, which may also be referred to as a tank ventilation system, is generally designated by the reference numeral 100.

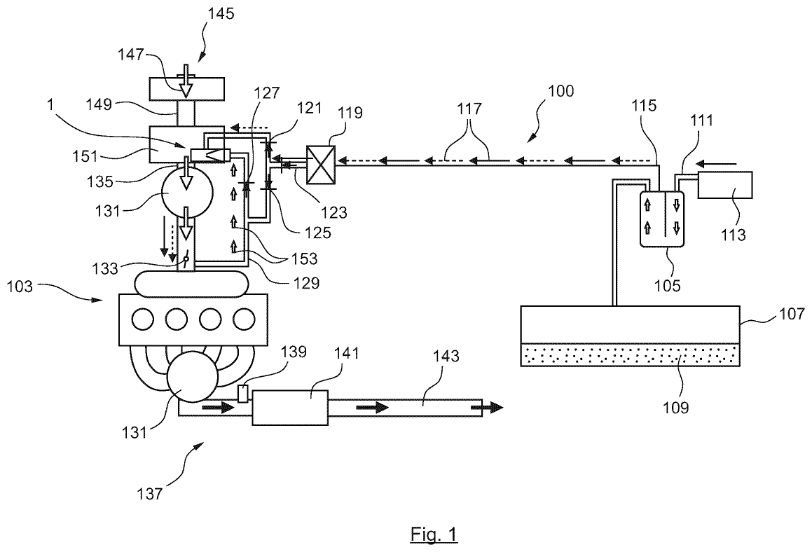

FIG. 1 shows a schematic representation of a fuel tank ventilation system 100 according to the disclosure, which is integrated in a motor vehicle engine 103 and is capable of cleaning or flushing a cleaning device 105, such as an activated carbon filter, of a fuel tank 107 which is at least partially filled with fuel 109. Vaporised hydrocarbons from the fuel tank 107 enter the activated carbon filter 105. The activated carbon filter 105 may further be in fluid communication with the environment, in particular with ambient air, which is schematically represented by a pipeline indicated by the reference numeral 111. Cleaning devices, such as an air filter 113, and/or control valves may be integrated into the pipeline 111 in order to be able to pressurise the activated carbon filter 105 with ambient air, for example to equalise the pressure within the fuel tank 107. The activated carbon filter 105 is connected to the vacuum generator 1 via an intake duct 115. The sequence of dashed and solid arrows along the intake duct 115 is provided with the reference numeral 117 and indicates the fuel/air mixture produced during cleaning of the activated carbon filter 105.

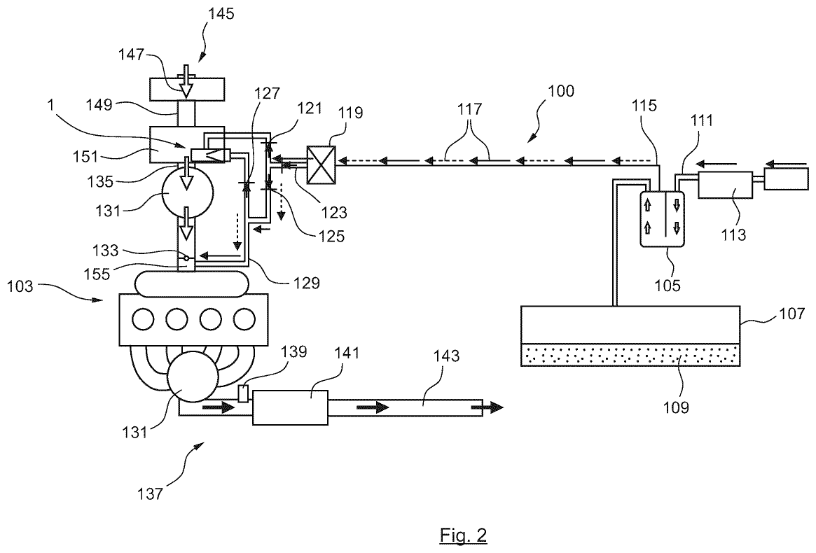

A tank vent valve 119 is connected between the activated carbon filter 105 and the vacuum generator 1, by means of which the cleaning of the activated carbon filter 105 can be controlled. Downstream of the tank vent valve 119, several check valves 121, 123, 125, 127 are integrated, which allow fluid flow in only one flow direction, which is indicated by the respective arrow direction. Downstream of the tank vent valve 119, the intake duct 115 continues and opens into the vacuum generator 1. Furthermore, the vacuum generator 1 is in fluid communication with an overpressure duct 129, which taps overpressure fluid downstream of a turbo charger 131 and downstream of a throttle valve 133 and diverts it into the vacuum generator 1. The vacuum generator 1 is further connected to a third conduit, namely an exhaust duct 135, which leads back to the motor vehicle engine 103. According to the exemplary embodiment shown in FIG. 1, the motor vehicle engine 103 is designed as an internal combustion engine. This means that the fuel/air mixture 117 from the activated carbon filter 105 can be fed to a combustion process via the exhaust duct 135. The fuel-air components extracted from the activated carbon filter 105 are purified and discharged into the environment via an exhaust system, which is indicated schematically by the reference numeral 137, in which, for example, a lambda probe 139 and an exhaust gas conditioning device 141, such as a catalytic converter, can also be integrated, and an associated exhaust conduit 143. FIG. 1 also shows that the turbo charger 131 is connected via an air intake device 145 for drawing in ambient air, which is indicated by the arrow with the reference sign 147. Schematically, a conduit section 149 leads from the environment towards the turbo charger 131. According to the exemplary embodiment indicated in FIGS. 1 and 2, the vacuum generator is integrated into a resonator housing 151 which serves to reduce vibrations and/or oscillations, in particular to dampen and/or insulate them.

Two different operating states of the fuel tank ventilation 100 are explained by way of example using FIGS. 1 and 2. FIG. 1 schematically shows a load condition of the motor vehicle engine 103 in which the throttle valve 133, which can also be the turbocharger valve, is open. In the load state according to FIG. 1 and with the throttle valve 133 fully open, there is only a slight vacuum in the intake section (upstream of the turbo charger 131) with respect to the activated charcoal filter 105, so that cleaning of the activated charcoal filter 105 is only reliably made possible by using the vacuum generator 1 according to the disclosure. The vacuum generator 1 causes fluid flow in the overpressure section downstream of the throttle valve 133 to be fed to the vacuum generator 101, indicated by the arrows with the reference sign 153, so that, using the Venturi and/or Bernoulli effect, a vacuum is generated by means of the vacuum generator 1 in such a way that sufficient pressure difference results between the intake section and the activated carbon filter 105 to draw off or suck in the fuel/air mixture 117 from the activated carbon filter 105.

In the operating state shown in FIG. 2, in particular a non-load operating state of the turbo charger 131 in which the throttle valve 133 is closed. Due to the closed throttle valve 133, a vacuum is created in a conduit section 145 downstream of the throttle valve 133 relative to the activated carbon filter 105, which is sufficient to draw fluid, namely the fuel/air mixture 117, out of the activated carbon filter 105 or to draw it in and feed it to the motor vehicle engine 103. It can be seen here that the check valves 121 to 127 are partially active here. The vacuum generator 1 is circumvented or bypassed in the no-load operating state as shown in FIG. 2. The fuel/air mixture 117 passes from the activated carbon filter 105 directly via the overpressure duct 129, in the opposite direction of flow compared to FIG. 1, into the motor vehicle engine area 103, in particular in order to be fed to a combustion process there.

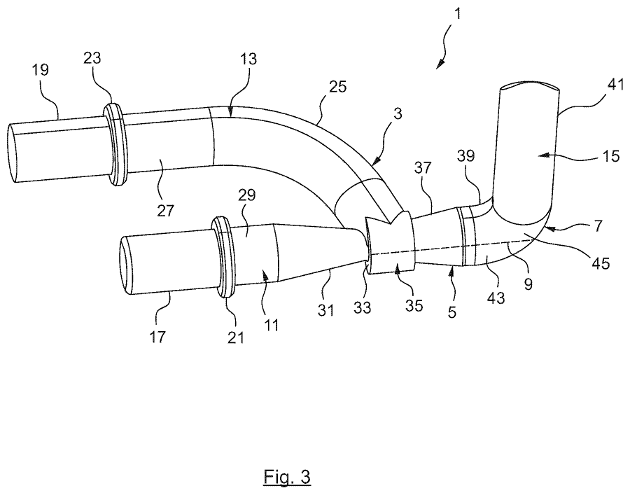

With reference to FIGS. 3 to 8, exemplary embodiments of vacuum generators 1 according to the disclosure for fuel force ventilation are now described. Identical or similar components are given identical or similar reference numbers. To avoid repetition, the description of the exemplary embodiments is limited to the surrounding differences with respect to the various embodiments.

FIG. 3 shows a perspective view of an exemplary embodiment of a vacuum generator 1 according to the disclosure for fuel tank ventilation, for example for use in a tank ventilation system 100 according to the disclosure as shown in FIGS. 1, 2. The vacuum generator 1 comprises a fluid feed-through body which is generally provided with the reference numeral 3. The fluid feed-through body 3 comprises at least two plastic parts 5, 7 which are connected to each other along a connecting line shown by means of a dotted line (reference numeral 9), in particular a weld, for example by means of ultrasonic welding. The fluid feed-through body 3 comprises an overpressure conduit section 11 connectable to an overpressure source, for example downstream of a turbo charger 131 and downstream of a throttle valve 133, for example in the overpressure section 155. Furthermore, the vacuum generator 1 comprises an intake conduit section 13 connectable to the fuel tank 107 and in particular to the activated carbon filter 105. Furthermore, the vacuum generator 1 comprises a third conduit section, namely a delivery conduit section 15, which is connectable to the motor vehicle engine 103. The conduit sections 11, 13, 15 have substantially a tubular structure and are formed substantially along their full longitudinal extension with a constant wall thickness and/or cylindrically.

At the initial ends of the overpressure conduit section 11 and the intake conduit section 13, the overpressure conduit section 11 and the intake conduit section 13 have conduit connections 17, 19 for connection, for example, to a hose, conduit or the like of the fuel tank ventilation 100. The conduit connections 17, 19 may be delimited by a stop projection 21, 23, which may also serve to seal against the conduit to be connected or the like. The intake conduit section 13 comprises a curved conduit section 25 which is curved from and extends in the direction of the overpressure conduit section 11 from the straight pipe structure 27.

The overpressure conduit section 11 also has a cylindrical pipe section 29 connected to the conduit connection 17. A venturi nozzle 31, which is realised by a tapering, in particular frustoconical, pipe structure, directly adjoins this. Viewed in the direction of fluid flow through the overpressure conduit section 11, the venturi nozzle 31 forms a vacuum side 33 downstream, into which the intake conduit section 13 opens. As can be seen in FIGS. 3 to 8, the vacuum side 33 has a vacuum chamber 35 immediately adjacent to the venturi nozzle 31, which is also part of the fluid feed-through body 3. The vacuum chamber 35 also forms a union area between the three conduit sections: the overpressure conduit section 11 and the intake conduit section 13 open into the vacuum chamber 35; the delivery conduit section 15 extends away from the vacuum chamber 35. The delivery conduit section 15 has a pipe section 37 directly adjoining the vacuum chamber 35 and widening in cross-section, to which a curved angled conduit section 39 is connected, as well as a substantially cylindrical pipeline section 41 adjoining it. A conduit connection (not shown) substantially analogous to the conduit connections 17, 19 can also be present at this.

FIG. 3 shows that the fluid feed-through body 3 consists of two plastic parts 5, 7. Furthermore, it is apparent from FIG. 3 that the venturi nozzle 31 is made from a single piece of plastic in accordance with the disclosure. According to the exemplary embodiment shown in FIG. 3, the overpressure conduit section 11, the venturi nozzle 31, the intake conduit section 13 and a particularly lower half of the pipeline 43 are made from one piece of plastic, namely in particular by injection moulding. This makes it particularly easy to realise a compact fluid feed-through body 3 whose shape is flexible and which is inexpensive and easy to manufacture. Furthermore, it is ensured that access to the venturi nozzle 31 is avoided in a non-destructive manner, thus also enabling the increasing requirements for air purification in the motor vehicle sector. Along the weld seam 9 the two plastic pieces 5, 7 are welded together. In particular, it can be seen that the delivery conduit section 15 has a particularly lower half of the pipeline 43 and a particularly upper half of the pipeline 45, which are welded together along the weld seam 9. Furthermore, it can be seen that the vacuum chamber 35 also consists of the two plastic pieces 5, 7 and is hermetically sealed along the weld seam 9, in particular to enable sufficient fluid tightness to reliably provide and ensure the vacuum for drawing off or drawing in the fuel/air mixture 117 from the activated carbon filter 105.

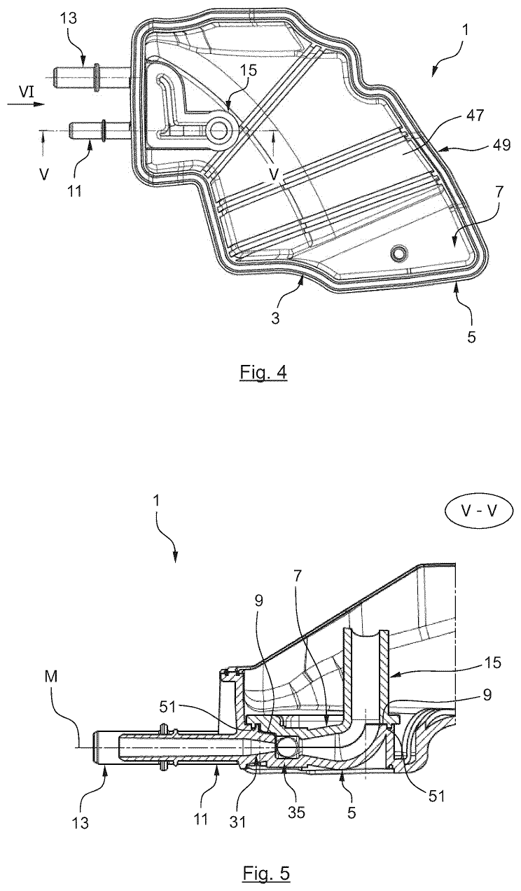

FIGS. 4 to 8 describe a further exemplary embodiment of a vacuum generator 1 according to the disclosure. In contrast to the embodiment of the vacuum generator 1 according to FIG. 3, the vacuum generator 1 according to FIGS. 4 to 8 is integrated into a resonator housing 47 of a resonator 49 for vibration and/or noise reduction in the motor vehicle engine 103. The advantage is that components which are present anyway are used to fulfil a further function, namely fuel tank ventilation. The at least two plastic parts 5, 7, which form the fluid feed-through body 3, are essentially planar and shell-like and are welded together to hermetically seal the fluid feed-through body 3 (e.g. FIG. 5; connecting line 9).

FIG. 4 shows a top view of the vacuum generator 1 integrated in the resonator housing 47. The overpressure conduit section 11 and the intake conduit section 13 protrude laterally from the housing. The delivery conduit section 15 protrudes from the drawing plane. The overpressure conduit section 11 and the intake conduit section 13 extend substantially parallel, at least in sections, outside the resonator housing 47. FIG. 5 shows that the overpressure conduit section 11 and the intake conduit section 13 lie in a plane. Furthermore, a centre axis M, indicated by a dashed line, is at the same level with respect to the overpressure conduit section 1 and the intake conduit section 13. The centre axis M further defines a demoulding direction E of a not shown slider in a not shown injection mould when manufacturing the plastic part 5.

FIG. 5 also shows the component separation between the two plastic parts 5, 7 and their hermetic sealing via the connection indicated by the reference number 9 and may be realised as a weld seam. The one lower plastic part 5 completely forms the overpressure conduit section 11 together with the venturi nozzle 31 and the intake conduit section 13 and forms at least one part, in particular one half, such as a lower side, of the vacuum chamber 35 as well as one conduit half of the delivery conduit section 15. The two plastic parts 5, 7 have at least one mounting element 51 on the connecting/welding surfaces facing each other, generally indicated by the connecting line 9, which enables the two plastic parts 5, 7 to be easily mounted and precisely positioned on each other. According to the exemplary embodiment shown in FIG. 5, the mounting elements 51 comprise mounting projections attached to one of the plastic parts 7 and mounting recesses attached to the other of the two plastic parts 5. The mounting projections and the mounting recesses are shape-matched to one another and can engage in one another in order to fix the two plastic parts 5, 7 in a positionally accurate manner relative to one another, in particular before the worker begins the welding process, for example.

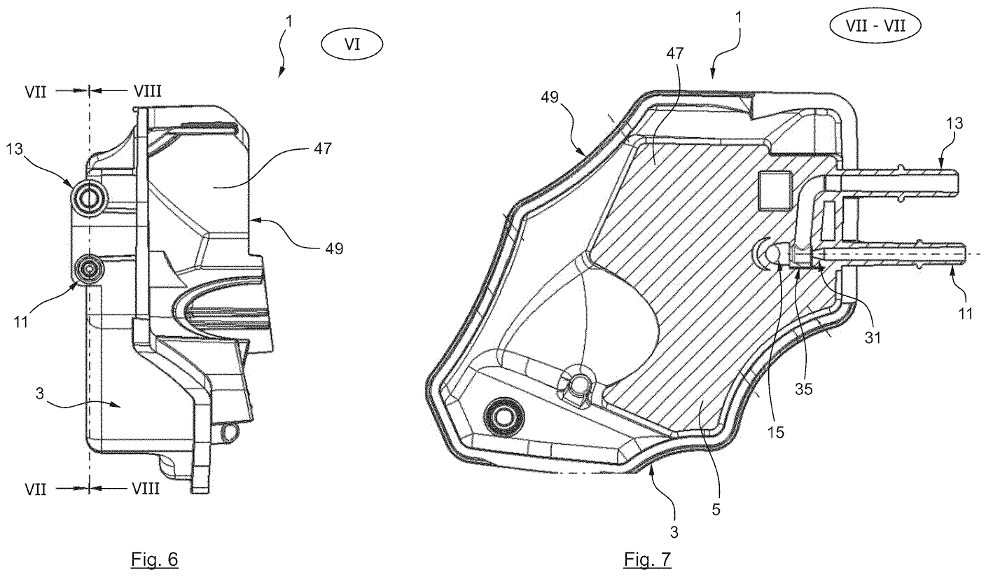

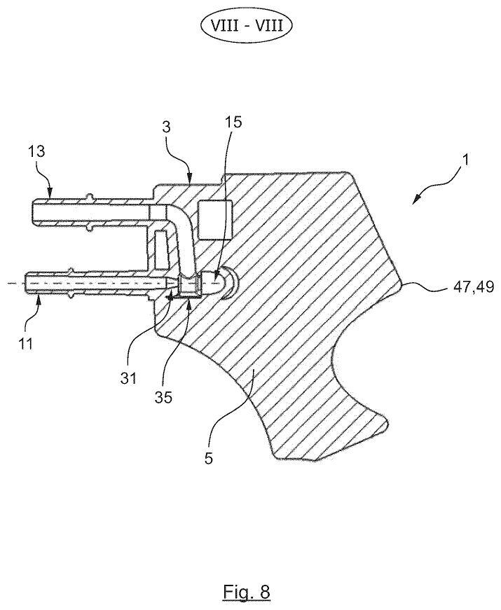

FIG. 6 shows a side view corresponding to the arrow VI in FIG. 4, looking at the entrances to the overpressure conduit section 11 and the intake conduit section 13. FIGS. 7 and 8 each show a sectional view corresponding to the line VII-VII and VIII-VIII respectively in FIG. 6. It can be seen in FIG. 6 that the sectional plane is essentially level with the centre axis M through the overpressure conduit section 11 and the intake conduit section 13. The synopsis of FIGS. 6 to 8 also shows the structure of the vacuum generator 1 according to the disclosure and in particular the formation of the fluid feed-through body 3, wherein the focus is on how the plastic parts 5, 7 are formed and joined together.

According to the exemplary embodiment in FIGS. 4 to 8, the lower plastic part 5 shown by hatching in FIGS. 7 and 8 comprises both the intake conduit section 13 and the overpressure conduit section 11 including the venturi nozzle 31. An intersection or connecting plane between the two plastic parts 5, 7 is arranged above the plane in which the centre axes M of the overpressure conduit section 11 and intake conduit section 13 lie, as can be seen from the synopsis of FIGS. 5 to 8. In FIGS. 7, 8 the delivery conduit section 15 is therefore only indicated downstream of the vacuum chamber 35. It is clearly recognisable from all the figures that the venturi nozzle 31 is made from a single piece of plastic, in particular formed exclusively by the lower plastic part 5.

The features disclosed in the foregoing description, the figures and the claims may be of importance for the realisation of the disclosure in the various embodiments, both individually and in any combination.

### Reference List

1 Vacuum generator
3 Fluid feed-through body
5, 7 Plastic part
9 Connecting line
11 Overpressure conduit section
13 Intake conduit section
15 Delivery conduit section
17, 19 Conduit connection
21, 23 Stop projection
25 Curved conduit section
27 straight pipe structure
29 cylindrical pipe section
31 Venturi nozzle
33 Vacuum side
35 vacuum chamber
37 pipe section
39 Angled conduit section
41 Cylindrical pipeline section
43, 45 Half of the pipeline
47 Resonator housing
49 resonator
51 Mounting element
100 Fuel tank ventilation
103 Motor vehicle engine
105 Cleaning device
107 Fuel tank
109 Fuel
111 Pipeline
113 Cleaning device
115 intake duct
117 Fuel/air mixture
119 tank vent valve
121, 123 Check valve
125, 127 Check valve
131 Turbo charger
133 Throttle valve
135 Exhaust duct
137 exhaust system
139 Lambda probe
141 exhaust gas conditioning device
143 Exhaust conduit
145 air intake device
147 ambient air
149 Conduit section
151 Resonator housing
153 arrow
155 Overpressure section
M Centre axis
E Demoulding direction

1. A vacuum generator for fuel tank ventilation, comprising:
a fluid feed-through body including at least two plastic parts, the fluid feed-through body having:
an overpressure conduit section adapted to be connected to an overpressure source,
an intake conduit section adapted to be connected to the fuel tank, and
a delivery conduit section adapted to be connected to a motor vehicle engine; and
a venturi nozzle into which the overpressure conduit section leads, wherein the intake conduit section leads into a negative pressure side of the venturi nozzle, and wherein at least the venturi nozzle is made of one plastic piece.

2. The vacuum generator according to claim 1, wherein the at least two plastic parts injection-molded parts.

3. The vacuum generator according to claim 1, wherein the at least two plastic parts being welded together.

4. The vacuum generator according to claim 1, wherein:
the venturi nozzle is demolded by a slide in the injection mold, and/or
the venturi nozzle has a conical shape, at least in sections.

5. The vacuum generator according to claim 1, wherein: (a) the venturi nozzle and (b) the overpressure conduit section and/or the intake conduit section, are formed from a plastic piece forming one of the at least two plastic parts.

6. The vacuum generator according to claim 5, wherein the delivery conduit section is formed from a plastic piece with: (a) the venturi nozzle and (b) overpressure conduit section and/or intake conduit section.

7. The vacuum generator according to claim 1, wherein the at least one of the delivery conduit section and the overpressure conduit section us formed, at least in sections, by both of the at least two plastic parts.

8. The vacuum generator according to claim 1, wherein the at least two plastic parts each comprise a conduit half of at least one of the overpressure and delivery conduit sections, the at least two plastic parts being welded together to form the respective one of the overpressure and delivery conduit sections.

9. The vacuum generator according to claim 1, wherein the venturi nozzle and the overpressure conduit section are demolded in a demolding direction in an injection mold.

10. The vacuum generator according to claim 1, further comprising a vacuum chamber formed downstream of the venturi nozzle into which the intake conduit section opens, such that, when fluid flows through the overpressure conduit section as a result of a pressure difference between the vacuum chamber and the intake conduit section, fluid is drawable from the fuel tank via the intake conduit section into the vacuum chamber and the delivery conduit section.

11. The vacuum generator according to claim 1, wherein the intake conduit section and the overpressure conduit section lie in a plane and/or are oriented at least partially parallel to each other.

12. The vacuum generator according to claim 11, wherein a parting plane between the at least two plastic parts is parallel to the plane of the overpressure conduit section and the intake conduit section.

13. The vacuum generator according to claim 1, wherein at least one of the at least two plastic parts is planar and/or shell-like.

14. A fuel tank vent for a motor vehicle, comprising:
a fuel tank including a fluid cleaning element,
an intake duct fluidly connected to the fuel tank,
an overpressure duct adapted to be connected to an overpressure source,
a delivery duct adapted to be connected to a motor vehicle engine, and
a vacuum generator adapted to be fluidically connected to the intake duct, the delivery duct, and the overpressure duct.

15. The fuel tank vent according to claim 14, further comprising a resonator adapted to reduce vibration and/or noise and including a resonator casing in which the vacuum generator is integrated.

16. The fuel tank vent according to claim 14, wherein the overpressure duct is adapted to be connected downstream of a turbocharger and downstream of a throttle valve of a motor vehicle engine.

17. The fuel tank vent according to claim 14, wherein the vacuum generator comprises:
a fluid feed-through body including at least two plastic parts, the fluid feed-through body having:
an overpressure conduit section adapted to be connected to an overpressure source,
an intake conduit section adapted to be connected to the fuel tank, and
a delivery conduit section adapted to be connected to a motor vehicle engine; and
a venturi nozzle into which the overpressure conduit section leads, wherein the intake conduit section leads into a negative pressure side of the venturi nozzle, and wherein at least the venturi nozzle is made of one plastic piece.

18. The vacuum generator according to claim 1, wherein the overpressure conduit section is adapted to be connected downstream of a turbocharger and downstream of a throttle valve of a motor vehicle engine.

19. A vacuum generator, comprising:
a fluid feed-through body including at least two plastic parts, the fluid feed-through body having:
an overpressure conduit section adapted to be connected to an overpressure source,
an intake conduit section, and
a delivery conduit section; and
a venturi nozzle into which the overpressure conduit section leads, the venturi nozzle being made of one plastic piece and having a negative pressure side, wherein the intake conduit section leads into the negative pressure side of the venturi nozzle.
